(19) United States
(12) Patent Application Publication
(10) Pub. No.: US 2006/0257151 A1
(43) Pub. Date: Nov. 16, 2006

(54) (D) WDM communications network using back-up light sources

(75) Inventors: Thierry Zami, Massy (FR); Ludovic Noirie, Nozay (FR)

Correspondence Address: SUGHRUE MION, PLLC, 2100 PENNSYLVANIA AVENUE, N.W., SUITE 800, WASHINGTON, DC, 20037, US

(73) Assignee: ALCATEL

(21) Appl. No.: 11/398,532

(22) Filed: Apr. 6, 2006

(30) Foreign Application Priority Data
Apr. 7, 2005 (FR) 0550895

(51) Int. Cl. H04B 10/04

(52) U.S. Cl. 398/183

(57) ABSTRACT

A communications node (Nᵢ) for a wavelength division multiplex optical network includes local modulation means (MOD) adapted to modulate light having a selected wavelength delivered by a source (S1-S4) to deliver modulated optical signals and coupling means adapted to couple said local modulation means (MOD) firstly to a first optical fiber portion (PF1) conveying light having a selected wavelength delivered by a source belonging to a first remote node of said network and secondly to another source delivering light having that selected wavelength.

The invention relates to (Dense) Wavelength Division Multiplex ((D)WDM) optical networks and more particularly to flexibility within such networks.

In ((D)WDM) optical networks, spectral multiplexes of optical signals constructed by communications nodes (or stations) connected to the optical fibers of the network and representing data to be transmitted are conveyed in unidirectional or bidirectional optical fibers.

As the person skilled in the art is aware, these spectral multiplexes are constructed from light waves (or optical carriers) at different wavelengths modulated with the signals to be transmitted and supplied by light sources such as tunable-wavelength lasers or batteries of fixed-wavelength lasers. Each node generally has its own light source(s).

To limit costs, it is possible to install the sources in one of the nodes of the network and to distribute light at the various wavelengths to the other nodes of the network, which then have only to modulate the light with the signals to be transmitted. This solution is described in particular in the document by N. Takachio et al. “12.5 GHz spaced super-dense WDM ring network handling 256 wavelengths with tapped-type OADMs”, Paper WW2, OFC 2002, p. 349-350, and in the document by P. P. Iannone et al. “A 160 km transparent metro WDM ring network featuring cascaded erbium-doped waveguide amplifiers”, Paper WW3, OFC 2001.

Using tunable-wavelength lasers is not the optimum from the cost point of view.

Wavelength selection (by means of batteries of fixed-wavelength lasers) is effective, provided that a plurality of transmission modules share batteries of fixed-wavelength lasers installed in a centralized manner in one or more nodes. Because of insertion losses at the optical modulators in the nodes, it is essential to install a large number of in-line optical amplifiers to maintain a sufficiently high optical power level throughout the network. This significantly increases costs.

Moreover, regardless of the type of light source envisaged and the mode of routing light at different wavelengths at the modulator level, the problem of backing up the light sources arises because, in the event of a light source being no longer able to deliver one or more of the wavelengths used by the network, then data can no longer be transmitted and might be lost. To prevent this happening, the light sources must be backed up. For this purpose it has been proposed to associate locally with each source an identical back-up light source. However, that proves to be particularly costly and is also bulky.

An object of the invention is to improve upon the above situation.

To this end the invention proposes a communications node for a wavelength division multiplex optical network, the node including local modulation means adapted to modulate light having a selected wavelength delivered by a source to deliver modulated optical signals.

The communications node is characterized in that it includes coupling means adapted to couple the local modulation means firstly to a first optical fiber portion conveying light having a selected wavelength delivered by a source belonging to a first remote node of the network and secondly to another source delivering light having that selected wavelength.

As a result, the light sources are backed up and it is not necessary to use in-line optical amplifiers.

The communications node of the invention may have other features, and in particular, separately or in combination:

it may include a local light source constituting the other source; in this case its coupling means are adapted to couple the local modulation means either to the local light source when it is working normally or to the first optical fiber portion when the local light source is not working;

its coupling means may be adapted to couple each local light source to a second optical fiber portion coupled to a second remote node of the network;

it may include, firstly, first multiplexing means connected to the first optical fiber portion and adapted to deliver light having different wavelengths to two or more outputs, secondly, at least two local light sources each taking the form of a single-wavelength laser adapted to deliver at an output light having one of the wavelengths of the light delivered at the outputs of the first multiplexing means, and, thirdly, second multiplexing means having inputs respectively connected to the outputs of the local light sources and an output connected to the second optical fiber portion to feed it with wavelength division multiplexed light; in this case, its coupling means may, for example, include switches each dedicated to switching light having a single wavelength and each having a first input connected to one of the outputs of the first multiplexing means, a second input connected to the output of the local light source delivering light having the same wavelength as that of the light reaching the first input, and an output adapted to be coupled to one or the other of the first and second inputs and connected to the modulation means;

its modulation means may also include a first portion dedicated to protected local modulation and a second portion dedicated to unprotected local modulation; in this case, each switch may, for example, have a first output connected to one of the inputs of the first portion of the modulation means and a second output connected to one of the inputs of the second portion of the modulation means, the first and second outputs of each switch being adapted to be connected to the first or the second input of that switch;

a first variant may include, firstly, multiplexing means having an input and two or more outputs connected to the modulation means to feed them with light having different wavelengths and, secondly, a multiwavelength local light source adapted to deliver wavelength division multiplexed light at an output connected in particular to the second optical fiber portion; in this case, its coupling means include a switch having a first input connected to the first optical fiber portion, a second input connected to the output of the local light source, and an output adapted to be connected to its first input or to its second input and connected to the input of the multiplexing means to feed it with wavelength division multiplexed light;

a second variant may include, firstly, first multiplexing means having an input and two or more outputs connected to a first portion of the modulation means dedicated to protected local modulation to feed it with light at different wavelengths, secondly, second multiplexing means having an input and two or more outputs connected to a second portion of the modulation means dedicated to unprotected local modulation to feed it with light having said different wavelengths, and, thirdly, a multiwavelength local light source adapted to deliver wavelength division multiplexed light at an output connected in particular to the second optical fiber portion; in this case, its coupling means include a switch having a first input connected to the first optical fiber portion, a second input connected to the output of the local light source, a first output connected to the input of the first multiplexing means for feeding it with wavelength division multiplexed light, and a second output connected to the input of the second multiplexing means to feed it with wavelength division multiplexed light, the first and second outputs of the switch being adapted to be connected to its first input or to its second input;

a third variant may include, firstly, two or more local light sources each taking the form of a single-wavelength laser adapted to deliver at an output light having a single wavelength, secondly, first multiplexing means having inputs respectively connected to the outputs of the light sources and an output delivering wavelength division multiplexed light, and, thirdly, second multiplexing means having an input and outputs connected to the modulation means to feed them with demultiplexed light having the same wavelengths as the light delivered by the local light sources; in this case, its coupling means include, firstly, a first coupler having an input connected to the output of the first multiplexing means, a first output connected to that input and the second optical fiber portion, and a second output, secondly, a second coupler having an input coupled to the second output of the first coupler and first and second outputs connected to that input, thirdly, a circulator having an input/output connected to the first optical fiber portion, an input connected to the first output of the first coupler and adapted to be coupled to that input/output, and an output adapted to be coupled to that input/output, and, thirdly, a switch having first and second inputs respectively coupled to the second output of the second coupler and to the output of the circulator and an output adapted to be coupled to one or the other of its first and second inputs and connected to the input of the second multiplexing means; in the present context, the term “circulator” means a component whose input is a unidirectional input port and which can transmit optical signals at its input/output (which is a bidirectional input/output port), and whose output is a unidirectional output port that can be fed with optical signals via its input/output;

in one variant its coupling means may be adapted to couple the local modulation means either to the first optical fiber portion when light delivered by the source of the first node is being conveyed therein or to a second optical fiber portion conveying light having at least the selected wavelength delivered by a source belonging to a second remote node of the network and constituting the other source when light delivered by the source of the first node is not being conveyed in the first optical fiber portion;

it may include multiplexing means having an input and outputs connected to the modulation means to feed them with demultiplexed light having different wavelengths; in this case, its coupling means include, firstly, a coupler having an input connected to the first optical fiber portion and first and second outputs connected to that input, secondly, a circulator having an input/output connected to the second optical fiber portion, an input connected to the first output of the coupler and adapted to be coupled to that input/output, and an output adapted to be coupled to that input/output, and, thirdly, a switch having first and second inputs respectively connected to the second output of the coupler and to the output of the circulator and an output adapted to be coupled to one or the other of its first and second inputs and connected to the input of the multiplexing means;

its coupling means may instead include, firstly, a coupler having an input connected to the first optical fiber portion and first and second outputs connected to that input, secondly, a circulator having an input/output connected to the second optical fiber portion, an input connected to the first output of the coupler and adapted to be coupled to that input/output, and an output adapted to be coupled to that input/output, thirdly, first multiplexing means having an input connected to the second output of the coupler and outputs adapted to deliver demultiplexed light having different wavelengths, fourthly, second multiplexing means having an input connected to the output of the circulator and outputs adapted to deliver demultiplexed light having different wavelengths, and, fifthly, switches each dedicated to switching light having a single wavelength and each having a first input connected to one of the outputs of the first multiplexing means, a second input connected to one of the outputs of the second multiplexing means, and one or more outputs adapted to be coupled to one or the other of the first and second inputs and connected to the modulation means.

The invention also proposes a wavelength division multiplex optical network equipped with two or more communications nodes of the type described above.

The invention is particularly well adapted, although not exclusively so, to (D)WDM optical networks having a ring or bus structure.

Other features and advantages of the invention become apparent on reading the following detailed description and examining the appended drawings, in which:

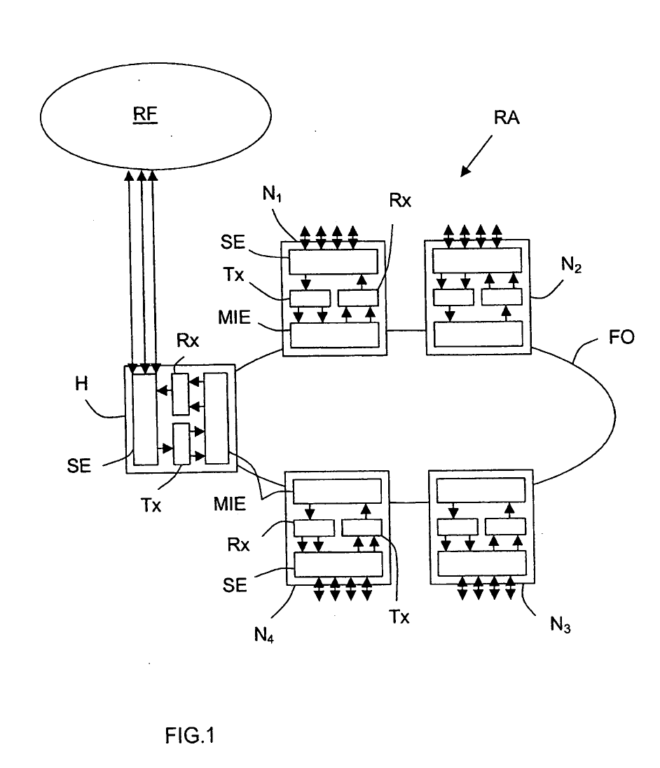

FIG. 1 is a functional block diagram of a ring communications network connected to a backbone network;

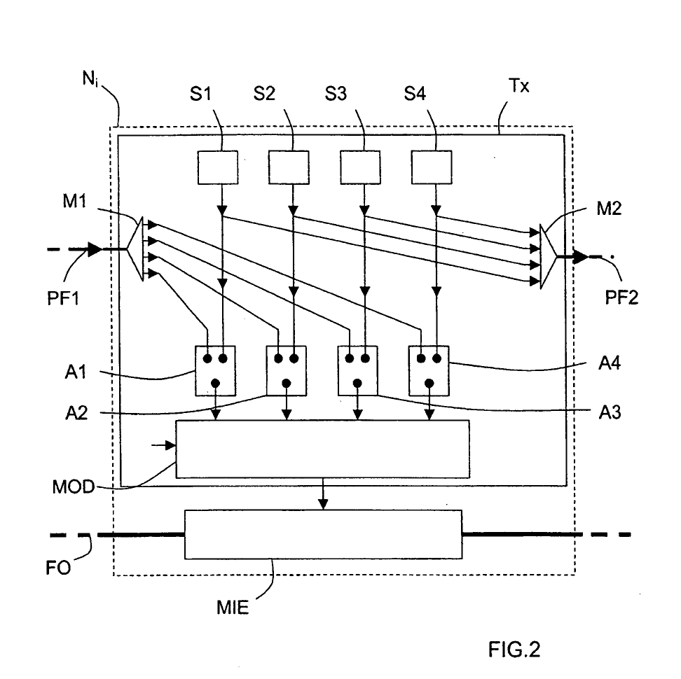

FIG. 2 is a diagram of a first embodiment of a communications node of the invention;

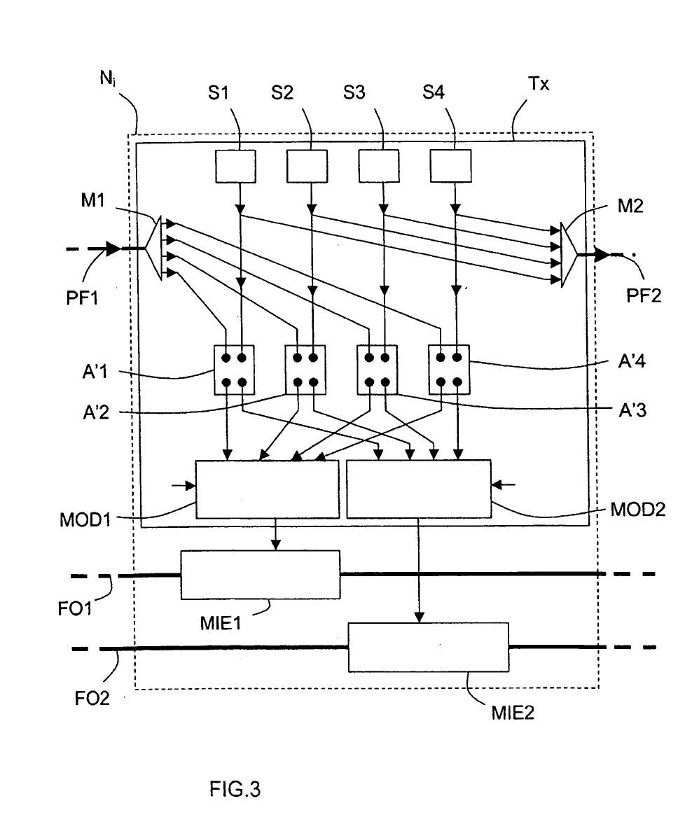

FIG. 3 is a diagram of a second embodiment of a communications node of the invention;

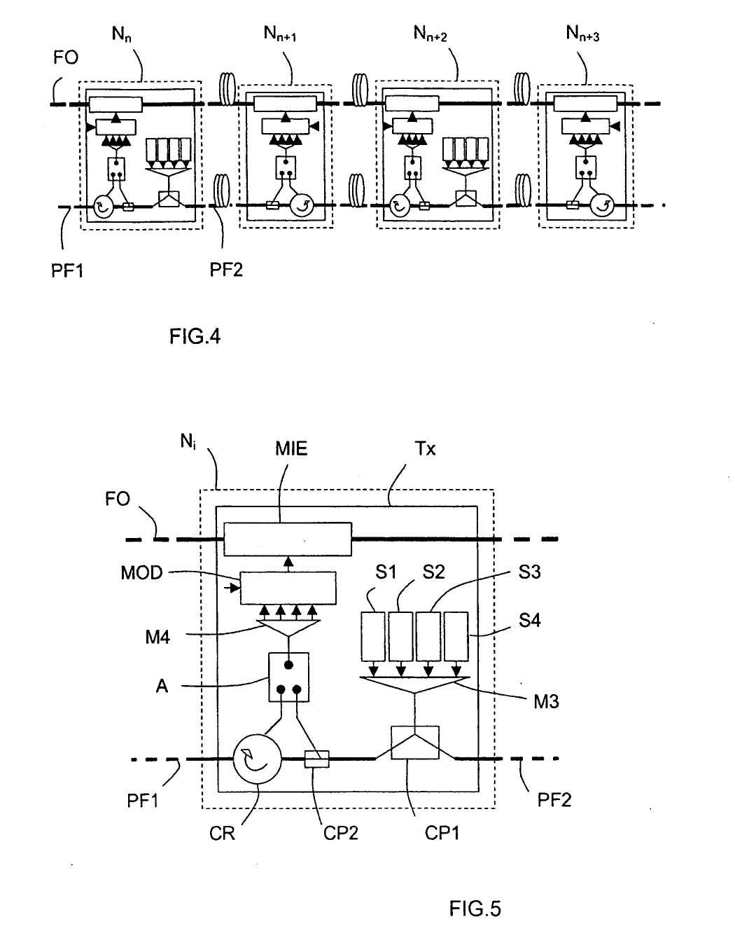

FIG. 4 is a diagram of a portion of a network equipped alternately with third and fourth embodiments of communications nodes of the invention;

FIG. 5 is a more detailed diagram of a third embodiment of a communications node from FIG. 4;

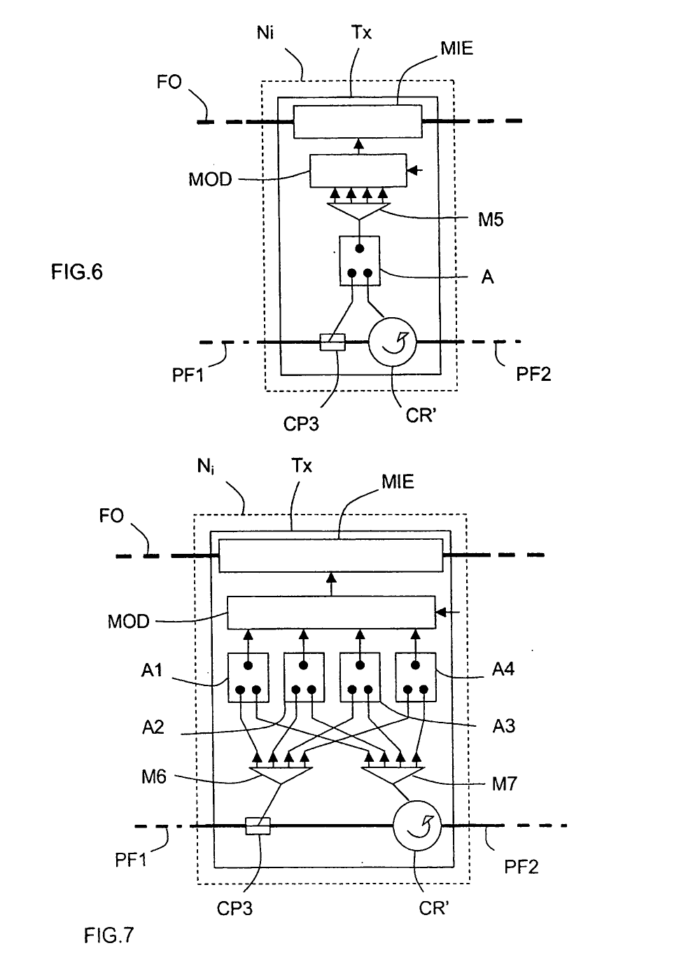

FIG. 6 is a more detailed diagram of a fourth embodiment of a communications node from FIG. 4;

FIG. 7 is a diagram of a fifth embodiment of a communications node of the invention;

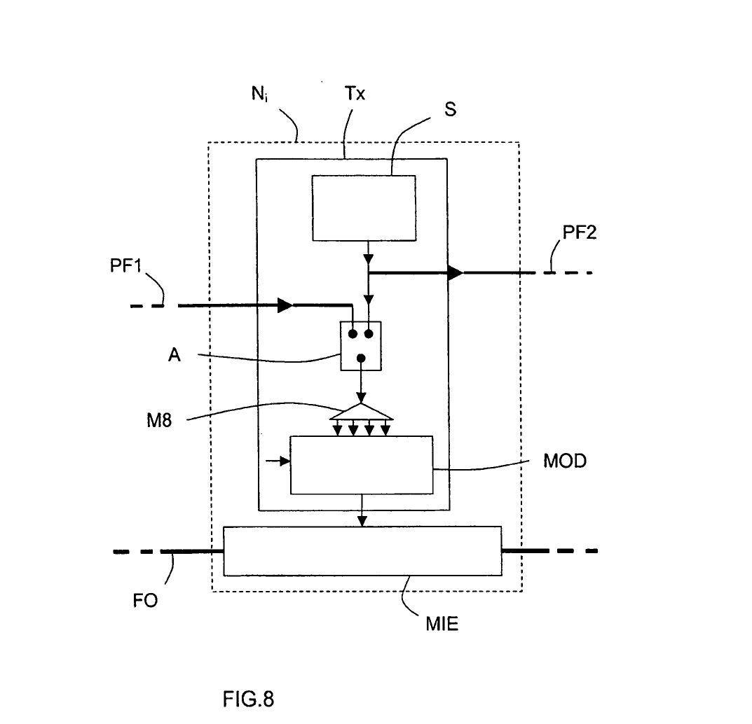

FIG. 8 is a diagram of a sixth embodiment of a communications node of the invention; and

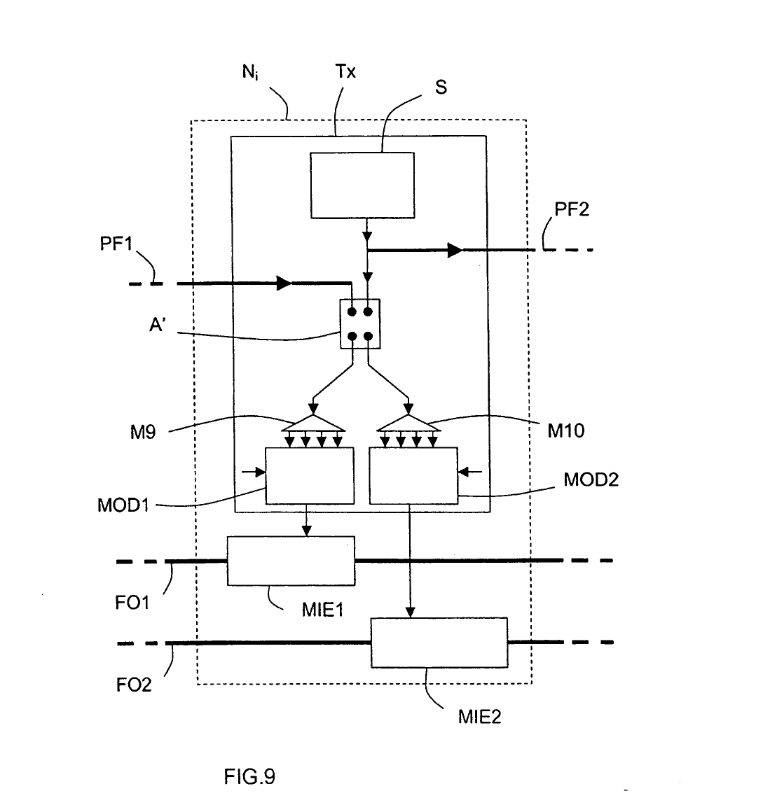

FIG. 9 is a diagram of a seventh embodiment of a communications node of the invention.

The appended drawings constitute part of the description of the invention and may, if necessary, contribute to the definition of the invention.

An object of the invention is to provide flexibility in a (Dense) Wavelength Division Multiplexing ((D)WDM) network by backing up (protecting) its light sources to minimize the use of in-line optical amplifiers.

The optical network considered below by way of non-limiting example is a “circuit mode” network, for example a metropolitan area telecommunications access network. The invention is not limited to that application alone, however. Moreover, the optical network may be a ring network, although this is not obligatory. The invention applies to other types of optical network, and in particular to optical networks having a bus structure.

FIG. 1 represents a simplified example of a ring network RA which conventionally includes an access node H (also known as a “hub” or a point of presence), which is connected to one or both ends of one or more optical fibers FO adapted to transmit data in the form of spectral multiplexes of optical signals, and a plurality of communications nodes (also known as stations) Nᵢ (here i takes values from 1 to 4, but may take any value greater than or equal to two (2)), which are optically coupled to the fiber(s) FO at passive optical add and drop multiplexers (OADM), where applicable of the reconfigurable (R-OADM) type.

The ring network RA is generally connected to another network RF, known as the federator or backbone network, via the access node H.

The network RA is considered below by way of illustrative example to include a transmission optical fiber FO conveying uplink traffic and downlink traffic. The network RA may equally include another bidirectional optical fiber dedicated to traffic protection in the event of failure on the bidirectional optical fiber FO. Alternatively, the network RA could include a first unidirectional transmission optical fiber dedicated to uplink traffic from the nodes Nᵢ to the access node H and a second unidirectional transmission optical fiber dedicated to downlink traffic from the access node H to the stations Nᵢ. In this latter case, the first and second optical fibers may be backed up by first and second back-up optical fibers.

Each node Nᵢ, including the access node H, includes:

an add/drop multiplexer MIE for adding spectral multiplexes to and dropping them from the optical fiber FO;

a traffic switch SE to which user terminals (not shown) are connected;

one or more sender (or transmitter) modules Tx fed with data to be transmitted by the traffic switch SE and delivering spectral multiplexes of modulated optical signals at different wavelengths (representing data) to be added to the traffic being conveyed in the optical fiber FO by the add/drop multiplexer MIE; and

one or more receiver modules Rx supplied with spectral multiplexes of modulated optical signals at different wavelengths (representing data) by the add/drop multiplexer MIE and extracting data from those multiplexes in order for it to be forwarded to the user terminals concerned by the traffic switch SE. Because the invention does not relate to the receiver modules Rx, they are not described in detail below.

It is important to note that the definition given above of a sender module (Tx) is not the usual one. A sender module usually includes an individual modulator and a single source delivering single-wavelength light to said modulator. A plurality of sender modules are therefore generally disposed in parallel and the outputs of their respective individual modulators feed an add/drop multiplexer MIE connected to an optical fiber. Here, to simplify the drawings, a sender module (Tx) includes a multiwavelength light source or a plurality of single-wavelength light sources each coupled to one modulator. In FIGS. 2 to 9 the set of individual modulators is shown in the form of a single block MOD.

Moreover, the definition given above of a receiver module (Rx) is not the usual one. A receiver module usually includes a photodiode and a decision electronic bistable responsible for supplying a binary electrical signal synchronized to the clock extracted from the signal supplied by the photodiode. An individual receiver module usually processes only one optical channel at a time. A plurality of receiver modules are therefore generally disposed in parallel at the output of a multiplexer supplied with spectral multiplexes by an add/drop multiplexer MIE and the respective outputs of the decision bistable feed a traffic switch SE. Here, to simplify the drawings, a receiver module (Rx) includes a demultiplexer coupled to a plurality of individual receiver modules.

The access node H may also include storage means, such as electronic memories, for storing traffic, at least temporarily, and an Ethernet or IP electronic switch. generally referred to as a “concentrator” and equipped with optical/electrical/optical (O/E/O) converter means so as to be able to access all of the traffic being conveyed in the network (which here is a ring network).

As indicated above, the sender module Tx of each node Nᵢ includes a local optical modulator (MOD) that is fed with data to be transmitted by an electronic circuit and modulates light at different wavelengths with that data to deliver at its output modulated optical signals that are then multiplexed to constitute spectral multiplexes. Given the above definition, the local optical modulator (MOD) of the sender module Tx consists of a plurality of independent (or individual) modulators (or sub-portions) each of which modulates the light delivered by the light source that is associated with it in order to feed the inputs of a multiplexer whose output feeds the add/drop multiplexer MIE coupled to the optical fiber FO.

According to the invention, each node Nᵢ is connected to the adjacent nodes Nᵢ₋₁ and Nᵢ₋₁ by an additional optical fiber. Below, the expression “first portion (PF1)” refers to the portion of the additional optical fiber that connects a node Nᵢ to the node N₋₁, that precedes it and the expression “second portion (PF2)” refers to the portion of the additional optical fiber that connects a node Ni to the node Nᵢ₊₁ that follows it.

Moreover, and still in accordance with the invention, each node Nᵢ includes coupling means for coupling the local optical modulator (MOD), firstly, to a first portion (PF1) of the additional optical fiber conveying light having one or more selected wavelengths delivered by a light source belonging to a first remote node of the network and, secondly, one or more other light sources delivering light having at least that selected wavelength. Given the above definition, each sub-portion of the local optical modulator (MOD) is coupled to the first portion (PF1) of the additional optical fiber.

A first embodiment of a communications node Ni of the invention is described next with reference to FIG. 2.

This first embodiment belongs to a first family of nodes having, firstly, one or more local light sources Sj that constitute the other light sources referred to above and, secondly, coupling means for coupling its local optical modulator MOD (in fact each of its sub-portions) either to the local light source Sj when it is working normally or to the first portion PF1 (of the additional optical fiber) if the local light source Sj is not working.

In the example shown in FIG. 2, the sender module Tx of the node Nᵢ has four light sources S1 to S4 (j=1 to 4) of the single-wavelength laser type delivering light of fixed wavelength. The four local sources Sj therefore deliver light at four different wavelengths λ1 to λ4. However, j can take any non-zero value (j>0).

Here the coupling means couple each local light source Sj to one or more second portions PF2 of the additional optical fiber in order to insert therein light at each of the wavelengths λj.

The node Nᵢ is coupled to the first portion PF1 of the additional optical fiber by a demultiplexer M1 having one input (which is connected to the first portion PF1 in order to be fed with multiplexed light at the wavelengths λj coming from the preceding node Nᵢ₋₁) and as many outputs as there are different wavelengths λj (here there are four different wavelengths).

It is important to note that the wavelengths λj delivered by the local light sources Sj of the node Nᵢ are identical to those of the light being conveyed in the first portion PF1 of the additional optical fiber and that comes from the adjacent node Nᵢ₋₁.

The node Nᵢ is coupled to the second portion PF2 of the additional optical fiber by a multiplexer M2 having inputs connected to respective outputs of the local sources Sj and an output connected to the second fiber portion PF2 in order to feed it with multiplexed light at the wavelengths λj.

The coupling means also include switches Aj (here A1 to A4) each dedicated to routing light at one of the wavelengths λj.

Each switch Aj is here of the 2×1 type and has:

a first input that is connected to one of the outputs of the demultiplexer M1 so as to be fed with light at one of the wavelengths λj;

a second input that is connected to the output of the local source Sj that delivers light at the same wavelength λj as that reaching its first input; and

an output that is connected to the local modulator MOD (in fact to one of the sub-portions thereof) and that may be coupled to one or the other of the first and second inputs according to whether the local source Sj is not working or working.

With this arrangement, the demultiplexer M1 of each node Nᵢ of the network RA receives light at the (four) wavelengths λj transmitted to it via the first fiber portion PF1 by the (four) sources Sjᵢ₋₁ installed in the preceding node Nᵢ₋₁ and transmits to the node Nᵢ₊₁ that follows it the light at the (four) wavelengths λj generated by its (four) local sources Sjᵢ via its multiplexer M2 and the second fiber portion PF2. Here the additional optical fiber is a unidirectional fiber.

Accordingly, when the local sources Sj of the node Nᵢ are working, its switches Aj all couple their second input to their output so that the modulator MOD is fed with light delivered by said local sources Sj. If one of the local sources Sj of the node Nᵢ is no longer working, for example the local source S4, the corresponding switch λ4 couples its first input to its output in order for the modulator MOD to be fed with light at the wavelength λ4 delivered by the demultiplexer M1 and coming from the source S4ᵢ₋₁ of the preceding node Nᵢ₋₁ and the other switches A1 to A3 all couple their second input to their output in order for the modulator MOD to be fed with light at the wavelengths λ1 to λ3 delivered by the local sources S1 to S3.

Each local source Sjᵢ of each node Nᵢ is therefore backed up by the local source Sjᵢ₋₁ of the node Nᵢ₋₁ that precedes it.

In the FIG. 2 example, the switches Aj take the form of 2×1 optical switches. However, each switch Aj may take the form of a combination of optical gates.

A second embodiment of a communications node Nᵢ of the invention is described next with reference to FIG. 3.

This second embodiment also belongs to the first family of nodes and is in fact a variant of the first embodiment described above with reference to FIG. 2.

What distinguishes this second embodiment from the first embodiment is the fact that the modulator MOD has two portions MOD1 and MOD2 respectively dedicated to protected local modulation and unprotected local modulation.

The first modulator portion MOD1 (in fact each of its sub-portions) feeds a first add/drop multiplexer MIE1 that is coupled to a first optical fiber FO1. The second modulator portion MOD2 (in fact each of its sub-portions) feeds a second add/drop multiplexer MIE2 that is coupled to a (back-up) second optical fiber FO2.

Here the additional optical fiber is also a unidirectional fiber.

Because of this modification, each switch A′j is of the 2×2 type and has not only first and second inputs like the switch Aj but also first and second outputs coupled to the two portions MOD1 and MOD2, respectively, of the modulator MOD (in fact to each of their sub-portions) and adapted to be coupled to one or the other of the first and second inputs according to whether the corresponding local source Sj is working or not working.

This embodiment is suited to networks RA carrying protected traffic and unprotected traffic simultaneously. If all the local sources Sjᵢ of a node Nᵢ and the (remote) sources Sjᵢ₋₁ of the preceding node Nᵢ₋₁ are working normally, both portions MOD1 and MOD2 of the modulator MOD are fed with light coming from the local sources Sjᵢ and the (remote) sources Sjᵢ₋₁ of the preceding node Nᵢ₋₁, respectively. If one of the local sources Sjᵢ or the remote sources Sjᵢ₋₁ is not working, the switch A′jᵢ of the corresponding node Nᵢ substitutes for the light that it delivers that delivered by the remote source Sjᵢ₋₁ or the local source Sjᵢ.

Each local source Sjᵢ of each node Nᵢ is therefore backed up by the local source Sjᵢ₋₁ of the node Nᵢ₋₁ that precedes it.

This is of benefit only if each 2×2 switch A′j is of the “crossbar” type, i.e. adapted to be placed either in a first state in which the first input is connected to the first output and the second input is connected to the second output or in a second state in which the first input is connected to the second output and the second input is connected to the first output.

In the FIG. 3 example, the switches A′j take the form of 2×2 optical switches. However, each switch A′j may take the form of a combination of optical gates.

Third and fourth embodiments of a communications node Nᵢ of the invention are described next with reference to FIGS. 4 to 6.

To be more precise, FIG. 4 shows a portion of a network RA equipped alternately with third and fourth embodiments of the node Nᵢ. However, a different network may be envisaged in which all the nodes are identical to the third embodiment shown in FIG. 5.

Here the additional optical fiber is a bidirectional fiber.

The third embodiment, shown in FIG. 5, also belongs to the first family of nodes.

In this embodiment, the outputs of the (four) local sources Sj are coupled to (four) respective inputs of a multiplexer M3 whose output is coupled in particular by a first 1×2 coupler CP1 to the second portion PF2 of the additional optical fiber in order to feed it with wavelength division multiplexed light.

Moreover, the modulator MOD (in fact its sub-portions) is fed with demultiplexed light at the same wavelengths λj as the light delivered by the local sources Sj by the outputs of a demultiplexer M4 having an input connected to the output of a 2×1 switch A.

That switch A is of the type described above with reference to FIG. 2. It may also be replaced by a combination of optical gates.

The switch A has first and second inputs respectively connected to one of two outputs of a second coupler CP2 and to one of the outputs of a circulator CR.

The second coupler CP2 has an input coupled to one of the two outputs of the first coupler CP1, a first output coupled to the first input of the switch A, and a second output coupled to an input of the circulator CR.

The circulator CR has a (functionally unidirectional) output connected to the second input of the switch A, a (functionally unidirectional) input coupled to the second output of the second coupler CP2, and a (bidirectional) input/output connected to the first portion PF1 of the additional optical fiber and adapted to be coupled to its input or to its output. Accordingly, multiplexed light (at wavelengths λ1 to λ4) reaching its input/output from a preceding node (note that it is not obligatory for the preceding node to be an adjacent node) is delivered at its output in order to feed the second input of the switch A and the multiplexed light (at wavelengths λ1 to λ4) reaching its input from the local sources Sj is delivered at its input/output in order to feed the first portion PF1 of the additional optical fiber.

The first coupler CP1 is a 1×2 optical distributor, for example, delivering 60% of the power that it receives at its first output (which is coupled to the second portion PF2 of the additional optical fiber) and the remaining 40% of the power that it receives at its second output (which is coupled to the input of the second coupler CP2).

With this arrangement, if the local sources Sj of the node Nᵢ are working, each switch A couples its first input to its output so that the modulator MOD is fed with light delivered by said local sources Sj via the demultiplexer M4. If one of the local sources Sj of the node Nᵢ is no longer working, for example the local source S1, the switch A couples its second input to its output in order for the modulator MOD to be fed with light at wavelengths λ1 to λ4 delivered by the first portion PF1 of the additional optical fiber and coming either from the preceding node Nᵢ₋₁ if it is of the same type as itself (third embodiment) or from a node Nᵢ₋₂ of the same type as itself (third embodiment) placed two positions ahead of it if it is a node of a different type that precedes it (fourth embodiment—this situation is shown in FIG. 4).

The additional optical fiber being of the bidirectional type here, back-scattering may induce crosstalk between the multiplexed channels at different wavelengths. To prevent this, which would degrade the power, it is possible to shift the wavelengths delivered by the sources belonging to adjacent nodes of the same type by 0.1 nm to 0.3 nm. The shift must be sufficiently small to enable correct filtering in the network.

The fourth embodiment, shown in FIG. 6, belongs to a second family of nodes including coupling means for coupling its local optical modulator MOD either to the first portion PF1 of the additional optical fiber when the light delivered by the source of the first node (preceding node Nᵢ₋₁) is being conveyed therein or to the second portion PF2 of the additional optical fiber conveying light at least at the selected wavelength delivered by a source belonging to a second node (next node Nᵢ₊₁) and constituting the other source when the light delivered by the source of the first node (preceding node Nᵢ₋₁) is not being conveyed in the first portion PF1 of the additional optical fiber.

The nodes Nᵢ of this type therefore have no local light source Sj and are instead supplied by the light sources Sjᵢ₋₁ and Sjᵢ₊₁ of the nodes Nᵢ₋₁ and Ni+1 on their respective opposite sides.

In the embodiment shown in FIG. 6, the modulator MOD of the node Nᵢ is fed with demultiplexed light at the wavelength λj by the outputs of a demultiplexer M5 having an input connected to the output of a 2×1 switch A.

That switch A is of the type described above with reference to FIG. 2. It may also be replaced by a combination of optical gates.

The switch A has first and second inputs respectively connected to one of two outputs of a coupler CP3 and to the output of a circulator CR′.

The coupler CP3 has an input coupled to the first portion PF1 of the additional optical fiber, a first output coupled to the first input of the switch A, and a second output coupled to an input of the circulator CR′.

The circulator CR′ has a (functionally unidirectional) output connected to the second input of the switch A, a (functionally unidirectional) input coupled to the second output of the coupler CP3, and a (bidirectional) input/output connected to the first portion PF2 of the additional optical fiber and adapted to be coupled to its input or to its output. Accordingly, multiplexed light at wavelengths λ1 to λ4 reaching its input/output from the next node Nᵢ₊₁ (third embodiment) are delivered to its output in order to feed the second input of the switch A and multiplexed light at wavelengths λ1 to λ4 reaching its input from the preceding node Nᵢ₋₁ (third embodiment) is delivered to its input/output in order to feed the second portion PF2 of the additional optical fiber.

The coupler CP3 is a lx2 optical distributor, for example, delivering 80% of the power that it receives at its second output (which is coupled to the second portion PF2 of the additional optical fiber via the circulator CR′) and the remaining 20% of the power that it receives at its first output (which is coupled to the first input of the switch A).

With this arrangement, if the sources Sjᵢ₋₁ of the preceding node Nᵢ₋₁ are working, the switch A of the node Nᵢ couples its first input to its output so that the modulator MOD is fed with light delivered by said sources Sjᵢ₋₁ of the preceding node Nᵢ₋₁ via the first portion PF1 of the additional optical fiber and the demultiplexer M5. If one of the local sources Sjᵢ₋₁ of the preceding node Nᵢ₋₁, for example the local source S1, is no longer working, the switch A of the node Nᵢ couples its second input to its output in order for the modulator MOD to be fed with light at wavelengths λ1 to λ4 delivered by the sources Sjᵢ₊₁ of the next node Nᵢ₊₁ via the second portion PF2 of the additional optical fiber and the demultiplexer M5.

The third and fourth embodiments shown in FIGS. 5 and 6, respectively, do not back up the sources Sj individually. If one of them is no longer working, either locally or in an adjacent node, they must all be replaced by equivalent sources of an adjacent node.

The adaptations shown in FIG. 7 may be used to solve this problem, for example. It is important to note that FIG. 7 shows a fifth embodiment that is a variant of the fourth embodiment described above with reference to FIG. 6. However, the adaptations of this variant apply in the same manner to the third embodiment described above with reference to FIG. 5 (to be more precise to the components thereof that constitute its left-hand portion coupled to the local optical modulator MOD and to the first portion PF1 of the additional optical fiber).

Here the first coupler CP3 (or CP2) and the circulator CR′ (or CR) respectively connected to the first portion PF1 and the second portion PF2 of the additional optical fiber and connected to each other are retained. The adaptation consists in providing a first demultiplexer M6 and a second demultiplexer M7 and four 2×1 switches Aj.

To be more precise, each switch Aj is dedicated to one of the four wavelengths λj and has first and second inputs and an output connected to the local optical modulator MOD in order to feed it with demultiplexed light at the wavelengths λj received at one of its two inputs.

The first demultiplexer M6 has an input connected to the first output of the coupler CP3 (or CP2) and four outputs respectively connected to the first inputs of the four switches Aj. The second demultiplexer M7 has an input connected to the output of the circulator CR′ (or CR) and four outputs respectively connected to the second inputs of the four switches Aj. The outputs of the first demultiplexer M6 and the second demultiplexer M7, which are connected to the first and second inputs of the same switch Aj, feed the latter with light at the same wavelength (or at substantially the same wavelength, to prevent crosstalk).

With this arrangement, if the sources Sjᵢ₋₁ of the preceding node Nᵢ₋₁ are working, the switches Aj of the node Nᵢ all couple their first input to their output so that the modulator MOD is fed with light delivered by said sources Sjᵢ₋₁ of the preceding node Nᵢ₋₁ via the first portion PF1 of the additional optical fiber and the demultiplexer M6. If one of the local sources Sjᵢ₋₁ of the preceding node Nᵢ₋₁, for example the local source S1ᵢ₋₁, is no longer working, the switch A1ᵢ of the node Nᵢ couples its second input to its output in order for the modulator MOD to be fed with light at the wavelength λ1 delivered by the source S1ᵢ₊₁ of the next node Nᵢ₊₁ via the second portion PF2 of the additional optical fiber and the demultiplexer M7, and the switches A2ᵢ to A4ᵢ of the node Nᵢ couple their first input to their output in order for the modulator MOD to be fed with light delivered by the sources S2ᵢ₋₁ to S4ᵢ₋₁ of the preceding node Nᵢ₋₁ via the first portion PF1 of the additional optical fiber and the demultiplexer M6.

This provides individual protection of each light source Sj.

The switches Aj of this fifth embodiment are of the type described above with reference to FIG. 2. They may also be replaced by a combination of optical gates.

A sixth embodiment of a communications node Nᵢ of the invention is described with next with reference to FIG. 8.

This sixth embodiment also belongs to the first family of nodes. It may be considered a variant of the first embodiment described above with reference to FIG. 2.

What distinguishes this second embodiment from the first embodiment is primarily the fact that it has only one multiwavelength local light source S delivering wavelength division multiplexed light at an output.

The output of the source S is coupled, firstly, to the second portion PF2 of the additional optical fiber and, secondly, to one of the two inputs of a 2×1 switch A whose other input is coupled to the first portion PF1 of the additional optical fiber and whose output is connected to the input of a demultiplexer M8 in order to feed it with light at different multiplexed wavelengths λj and may be coupled to one or the other of the first and second inputs, according to whether the local source S is working or not working.

The switch A is of the type described above with reference to FIG. 2. It may also be replaced by a combination of optical gates.

The demultiplexer M8 has as many outputs as there are different wavelengths λj, each output being connected to the local optical modulator MOD in order to feed it with demultiplexed light at a particular wavelength.

With this arrangement, each node Nᵢ of the network RA receives at the first input of its switch A light at four wavelengths λj transmitted to it via the first portion PF1 by the source Sᵢ₋₁ installed in the preceding node Nᵢ₋₁ and transmits to the node Nᵢ₊₁ that follows it via the second portion PF2 light at four wavelengths λj generated by its local source Sᵢ. Here the additional optical fiber is a unidirectional fiber.

Accordingly, if the local source S of the node Nᵢ is working, its switch A couples its second input to its output so that its local modulator MOD is fed with light delivered by said local source S. If the local source S of the node Nᵢ is no longer working, its switch A couples its first input to its output in order for the modulator MOD to be fed with light at wavelengths λj from the source S of the preceding node Nᵢ₋₁ via the first portion PF1 of the additional optical fiber.

The local source Sᵢ of each node Nᵢ is therefore backed up by the local source Sᵢ₋₁ of the node Nᵢ₋₁ that precedes it.

A seventh embodiment of a communications node Nᵢ of the invention is described next with reference to FIG. 9.

This seventh embodiment also belongs to the first family of nodes. It is in fact a variant of the sixth embodiment described above with reference to FIG. 8.

What distinguishes this seventh embodiment from the sixth embodiment is the fact that the modulator MOD has two portions MOD1 and MOD2 respectively dedicated to protected local modulation and to unprotected local modulation.

The first portion MOD1 feeds a first add/drop multiplexer MIE1 coupled to a first optical fiber F01. The second portion MOD2 feeds a second add/drop multiplexer MIE2 coupled to a second (back-up) optical fiber F02.

Here the additional optical fiber is also a unidirectional fiber.

Because of this modification, the switch A′ is of the 2×2 type and has not only first and second inputs, like the switch A from FIG. 8, but also first and second outputs, which are respectively connected to a first demultiplexer M9 and to a second demultiplexer M10 the respective outputs whereof are coupled to the first portion MOD1 and the second portion MOD2 of the modulator MOD and can be coupled to one or the other of the first and second inputs, according to whether the local source S is not working or working.

As indicated above, this embodiment is suited to networks RA simultaneously carrying protected traffic and unprotected traffic. If the local source Sᵢ of a node Nᵢ and the (remote) source Sᵢ₋₁ of the preceding node Nᵢ₋₁ are working normally, the two portions MOD1 and MOD2 of the modulator MOD are fed with light from the local source S1 and the (remote) source Sᵢ₋₁ of the preceding node Nᵢ₋₁, respectively. If the local source Sᵢ or the remote source Sᵢ₋₁ is not working, the switch A′ᵢ of the corresponding node Nᵢ replaces the light that it should have delivered with light delivered by the remote source Sᵢ₋₁ or the local source Sᵢ.

The local source Sᵢ of each node Nᵢ is therefore backed up by the local source Sᵢ₋₁ of the node Nᵢ₋₁ that precedes it.

Once again, this is of benefit only if the (2×2) switch A′ᵢ is of the crossbar type.

The switch A′ is of the type described above with reference to FIG. 3. It may also be replaced by a combination of optical gates.

Several advantages emerge from the foregoing description of various embodiments of a communications node according to the invention:

only one additional optical fiber is required for sharing and backing up the light sources;

all the sources may be backed up separately or individually, without requiring complementary back-up sources, regardless of the number of network nodes;

the form of back-up provided is adapted to breaks in the fiber; and

certain embodiments enable the number of network components to be limited, in particular the number of light sources and (de)multiplexers; this can reduce power consumption, fabrication and operating costs and/or overall bulk.

The invention is not limited to the communications node and wavelength division multiplexing optical network embodiments described above by way of example only, and encompasses all variants that the person skilled in the art might envisage that fall within the scope of the following claims.

Accordingly, although there are described above embodiments of nodes in which the number of wavelengths used is equal to four (4), the invention is not limited to that number. In fact it applies to any number of wavelengths greater than or equal to one (1).

1. A communications node (Nᵢ) for a wavelength division multiplex optical network (RA), said node (Nᵢ) including local modulation means (MOD) adapted to modulate at least one light having a selected wavelength delivered by a source (Sj) to deliver modulated optical signals, and said node being characterized in that it includes coupling means adapted to couple said local modulation means (MOD) (i) to a first optical fiber portion (PF1) conveying at least one light having a selected wavelength delivered by a source belonging to a first remote node of said network and (ii) to at least another source delivering at least one light having that selected wavelength.

2. A communications node according to claim 1, characterized in that it includes at least a local light source (Sj, S) constituting said other source and said coupling means are adapted to couple said local modulation means (MOD) either to said local light source (Sj, S) when it is working normally or to said first optical fiber portion (PF1) when said local light source (Sj, S) is not working.

3. A communications node according to claim 2, characterized in that said coupling means are adapted to couple each local light source (Sj, S) to at least a second optical fiber portion (PF2) coupled to a second remote node (Nᵢ₊₁) of said network.

4. A communications node according to claim 3, characterized in that it includes, (i), first multiplexing means (M1) connected to said first optical fiber portion (PF1) and adapted to deliver light having different wavelengths to two or more outputs, (ii), at least two local light sources (Sj) each arranged in the form of a single-wavelength laser adapted to deliver at an output, light having a wavelength indentical to one of the wavelengths of the light delivered at the outputs of said first multiplexing means, and, (iii), second multiplexing means (M2) having inputs respectively connected to the outputs of said local light sources (Sj) and an output connected to said second optical fiber portion (PF2) to feed it with wavelength division multiplexed light, and wherein said coupling means include switches (Aj;A′j) each dedicated to switching light having a single wavelength and each having a first input connected to one of the outputs of said first multiplexing means (M1), a second input connected to the output of the local light source (Sj) delivering light having the same wavelength as that of the light reaching said first input, and at least one output adapted to be coupled to one or the other of said first and second inputs and connected to said modulation means (MOD).

5. A communications node according to claim 4, characterized in that said modulation means (MOD) include a first portion (MOD1) dedicated to protected local modulation and a second portion (MOD2) dedicated to unprotected local modulation and each switch (A′j) has a first output connected to one of the inputs of the first portion (MOD1) of the modulation means and a second output connected to one of the inputs of the second portion (MOD2) of the modulation means, said first and second outputs of each switch (A′j) being adapted to be connected to the first or the second input of that switch (A′j).

6. A communications node according to claim 3, characterized in that it comprises, (i), multiplexing means (M8) having an input and two or more outputs connected to said modulation means (MOD) to feed them with light having different wavelengths and, (ii), a multiwavelength local light source (S) adapted to deliver wavelength division multiplexed light at an output connected in particular to said second optical fiber portion (PF2), and wherein said coupling means include a switch (A) having a first input connected to said first optical fiber portion (PF1), a second input connected to the output of said local light source (S), and an output adapted to be connected to its first input or to its second input and connected to the input of said multiplexing means (M8) to feed it with wavelength division multiplexed light.

7. A communications node according to claim 3, characterized in that it includes, (i), first multiplexing means (M9) having an input and two or more outputs connected to a first portion (MOD1) of said modulation means dedicated to protected local modulation to feed it with light at different wavelengths, (ii), second multiplexing means (M10) having an input and two or more outputs connected to a second portion (MOD2) of said modulation means dedicated to unprotected local modulation to feed it with light having said different wavelengths, and, (iii), a multiwavelength local light source (S) adapted to deliver wavelength division multiplexed light at an output connected in particular to said second optical fiber portion (PF2), and said coupling means include a switch (A′) having a first input connected to said first optical fiber portion (PF1), a second input connected to the output of said local light source (S), a first output connected to the input of said first multiplexing means (M9) for feeding it with wavelength division multiplexed light, and a second output connected to the input of said second multiplexing means (M10) to feed it with wavelength division multiplexed light, said first and second outputs of the switch (A′) being adapted to be connected to its first input or to its second input.

8. A communications node according to claim 3, characterized in that it includes, (i), two or more local light sources (Sj) each taking the form of a single-wavelength laser adapted to deliver at an output light having a single wavelength, (ii), first multiplexing means (M3) having inputs respectively connected to the outputs of said light sources (Sj) and an output delivering wavelength division multiplexed light, and, (iii), second multiplexing means (M4) having an input and outputs connected to said modulation means (MOD) to feed them with demultiplexed light having the same wavelengths as the light delivered by said local light sources (Sj), and wherein said coupling means include, (i), a first coupler (CP1) having an input connected to the output of said first multiplexing means (M3), a first output connected to said input and said second optical fiber portion (PF2), and a second output, (ii), a second coupler (CP2) having an input coupled to the second output of said first coupler (CP1) and first and second outputs connected to said input, (iii), a circulator (CR) having an input/output connected to said first optical fiber portion (PF1), an input connected to the first output of said first coupler (CP2) and adapted to be coupled to said input/output, and an output adapted to be coupled to said input/output, and, (iv), a switch (A) having first and second inputs respectively coupled to the second output of the second coupler (CP2) and to the output of the circulator (CR) and an output adapted to be coupled to one or the other of its first and second inputs and connected to the input of said second multiplexing means (M4).

9. A communications node according to claim 1, characterized in that said coupling means are adapted to couple said local modulation means (MOD) either to said first optical fiber portion (PF1) when light delivered by the source of the first node is being conveyed therein or to a second optical fiber portion (PF2) conveying light having at least said selected wavelength delivered by a source belonging to a second remote node of said network (RA) and constituting said other source when light delivered by the source of the first node is not being conveyed in said first optical fiber portion (PF1).

10. A communications node according to claim 9, characterized in that it includes multiplexing means (M5) having an input and outputs connected to said modulation means (MOD) to feed them with demultiplexed light having different wavelengths and said coupling means include, (i), a coupler (CP3) having an input connected to said first optical fiber portion (PF1) and first and second outputs connected to said input, (ii), a circulator (CR′) having an input/output connected to said second optical fiber portion (PF2), an input connected to the first output of said coupler (CP3) and adapted to be coupled to said input/output, and an output adapted to be coupled to said input/output, and, (iii), a switch (A) having first and second inputs respectively connected to the second output of the coupler (CP3) and to the output of the circulator (CR′) and an output adapted to be coupled to one or the other of its first and second inputs and connected to the input of said multiplexing means (M5).

11. A communications node according to claim 9, characterized in that said coupling means include, (i), a coupler (CP3) having an input connected to said first optical fiber portion (PF1) and first and second outputs connected to said input, (ii), a circulator (CR′) having an input/output connected to said second optical fiber portion (PF2), an input connected to the first output of said coupler (CP3) and adapted to be coupled to said input/output, and an output adapted to be coupled to said input/output, (iii), first multiplexing means (M6) having an input connected to the second output of the coupler (CP3) and outputs adapted to deliver demultiplexed light having different wavelengths, (iv), second multiplexing means (M7) having an input connected to the output of the circulator (CR′) and outputs adapted to deliver demultiplexed light having different wavelengths, and, (v), switches (Aj) each dedicated to switching light having a single wavelength and each having a first input connected to one of the outputs of said first multiplexing means (M6), a second input connected to one of the outputs of said second multiplexing means (M7), and one or more outputs adapted to be coupled to one or the other of said first and second inputs and connected to said modulation means (MOD).

12. A wavelength division multiplex optical network (RA) characterized in that it includes at least two communications nodes (Nᵢ) according to claim 1 interconnected by first and second optical fiber portions (PF1, PF2).
